(19) United States
(12) Patent Application Publication
(10) Pub. No.: US 2013/0165555 A1
(43) Pub. Date: Jun. 27, 2013

(54) AQUEOUS PAINTING MATERIAL COMPOSITION

(71) Applicant: Tomohiro Sawa, Osaka-shi (JP)

(72) Inventor: Tomohiro Sawa, Osaka-shi (JP)

(73) Assignee: SAKURA COLOR PRODUCTS CORPORATION, Osaka-shi, Osaka (JP)

(21) Appl. No.: 13/820,967

(22) PCT Filed: Sep. 6, 2011
(86) PCT No.: PCT/JP2011/070215

§ 371 Date: Mar. 5, 2013

(30) Foreign Application Priority Data
Sep. 8, 2010 (JP) 2010-201222

(51) Int. Cl. C09D 101/04

(52) U.S. Cl. CPC C09D 101/04
USPC 524/44; 524/43

(57) ABSTRACT

The invention provides an aqueous painting material composition. which provides a coating film such that, after it has dried, it neither runs nor dissolves in water even if waterdrops adhere thereto, and such that it has water resistance in such a degree that, even if an extra layer of a second aqueous painting material composition is added thereon, it is not shifted, like the conventionally known emulsion paints, and further such that, even if it has adhered to a palette or a paintbrush, and dried, it can be readily washed away by washing it with water.

The aqueous painting material composition comprises water, a coloring pigment, a water-soluble resin, and a resin emulsion, wherein the aqueous painting material composition contains a hydroxyalkyl cellulose only as the water-soluble resin, and the resin emulsion in an amount of 0.1% by weight or more and less than 5% by weigh in a solid basis.

### FIELD OF THE INVENTION

The invention relates to an aqueous painting material composition which provides a coating film such that, after it has dried, even if waterdrops adhere thereto, it neither runs nor dissolves in water, and such that, even if an extra layer of a second aqueous painting material composition is added thereon as an undercoating film, it neither runs nor dissolves in water, that is, such that it has resistance to wetting in such a degree that it is not shifted even if an extra layer of a second aqueous painting material composition is added thereon, like the conventionally known emulsion paints, and further such that, even if it has adhered to a palette or a paintbrush, and dried, it can yet be readily washed away from the palette or the paintbrush by washing it with water.

### BACKGROUND OF THE INVENTION

The aqueous painting material composition that is conventionally known as an emulsion paint is a kind of aqueous painting material composition comprising water as a solvent, pigments as a colorant, and a resin emulsion as a fixing agent. When it is provided on a painting surface to form a coating film, the solvent evaporates from the coating film, and then the coating film has dried, the resin in the emulsion forms film, so that such a coating film as is water-insoluble and resistant to wetting with water is formed on the painting surface.

Such a conventionally known emulsion paint contains a large amount of a resin emulsion therein so that the resulting coating film may have a good resistance to wetting with water as mentioned above (see Patent Literatures 1 and 2). Thus, when it has adhered to a palette or a paintbrush, and it has dried, it cannot be removed from the palette or the paintbrush by washing it with water.

### PRIOR ART

### Patent Literatures

Patent Literature 1: JP 2003-221552A
Patent Literature 2: JP 2008⁻⁰³⁷⁹¹⁷A

### SUMMARY OF THE INVENTION

### Problems to be Solved by the Invention

The invention has been completed in order to solve the above-mentioned problems involved in the conventional emulsion paints. Therefore, it is an object of the invention to provide an aqueous painting material composition which provides a coating film such that, after it has dried, even if waterdrops adhere thereto, it neither runs nor dissolves in water, and such that, even if an extra layer of a second aqueous painting material composition is added thereon as an undercoating film, it has resistance to wetting in such a degree that it is not shifted, like the conventionally known emulsion paints, and further such that, even if it has adhered to a palette or a paintbrush, and dried, it can yet be readily washed away from the palette or the paintbrush by washing it with water.

### Means to Solve the Problems

The invention provides an aqueous painting material composition which comprises water, a coloring pigment, a water-soluble resin, and a resin emulsion, wherein the aqueous painting material composition contains a hydroxyalkyl cellulose only as the sole water-soluble resin, and the resin emulsion in an amount of 0.1% by weight or more and less than 5% by weight in a solid basis.

### Effects of the Invention

The aqueous painting material composition of the invention contains only a hydroxyalkyl cellulose as the sole water-soluble resin, together with a resin emulsion in an amount of from 0.1% by weight or more and less than 5% by weigh in a solid basis. Thus, it provides a coating film such that, after it has dried, even if waterdrops adhere to the coating film, it neither runs nor dissolves in water, and such that it has water resistance in such a degree that even if an extra layer of a second aqueous painting material composition is added thereon as an undercoating film, it is not shifted, like the conventional emulsion paints, and further such that, even if has adhered to a palette or a paintbrush, and dried, it can yet be readily removed from the palette or the paintbrush by washing it with water.

For the sake of simplicity hereinafter in the invention, when an aqueous painting material composition provides a coating film such that, after it has dried, even if waterdrops adhere thereto, it neither runs nor dissolves in water, and such that, even if an extra layer of a second aqueous painting material composition is added thereon as an undercoating film, it has water resistance in such a degree that it is not shifted, the aqueous painting material composition will be said to have performance of “water resistance”.

In turn, when an aqueous painting material composition provides a coating film such that, after it has adhered to a palette or a paintbrush, and dried, it can be removed from it by washing with water, the aqueous painting material composition will be said to have performance of “washability with water”. The aqueous painting material composition of the invention provides a coating film which has both water resistance and washability with water after it has dried.

### BEST MODE OF CARRYING OUT THE INVENTION

The aqueous painting material composition of the invention comprises water, a coloring pigment, a water-soluble resin, and a resin emulsion, wherein the aqueous painting material composition contains a hydroxyalkyl cellulose only as the water-soluble resin, and the resin emulsion in an amount of from 0.1% by weight or more and less than 5% by weigh in a solid basis.

### (Coloring Pigments)

The aqueous painting material composition of the invention contains a coloring pigment as a colorant. The coloring pigments used are not limited to specific ones, and any conventionally known pigments can be used. Thus, the coloring pigments used may be organic pigments, inorganic pigments, or metallic powder pigments. Examples of the coloring pigments used include, for example, titanium oxide, zinc oxide, carbon black, Iron Black, Aniline Black, Hansa Yellow, Benzidine Yellow, Tartrazine Lake, Permanent Yellow Toner, cadmium yellow, Benzidine Orange, Chrome Vermilion, cadmium orange, Permanent Orange GTR, Fast Orange Lake, Lake Red C, red iron oxide, Watchung Red, Brilliant Carmine 6B, Permanent Red 2B, Permanent Red FRLL. Carmine Lake, Quinacridone Red, Methylviolet Lake, Fast Violet B, Quinacridone Violet, Indanthrene Violet, Phthalocyanine Blue, Fast Sky Blue, Prussian Blue, Ultramarine, Victoria Blue Lake, Phthalocyanine Green, Mercallite Green Lake, Pigment Green B, Viridian, sienna, umber, aluminium powder, bronze powder, etc.

In addition to the coloring pigments mentioned above, a pigmented powder prepared by combining a dyestuff or a pigment with resin powder, a fluorescent pigment, a pigment prepared by coating the surface of natural mica with metallic oxides, a pearl pigment prepared by coating the surface of synthetic mica with metallic oxides, etc. can be used as a coloring pigment.

According to the invention, the aqueous painting material composition comprises such a coloring pigment as mentioned above in an amount of from 1% by weight to 60% by weight, preferably in an amount of from 10% by weight to 40% by weight. When the amount of the coloring pigment contained in the aqueous painting material composition is less than 1% by weight, the resulting aqueous painting material composition has a defect that it lacks in tinting strength. However, when the amount is more than 60% by weight, the resulting aqueous painting material composition has a defect that it has too high a viscosity so that it does not spread well and is inferior in painting ability when painting.

According to the invention, the aqueous painting material composition may further comprise an extender pigment when necessary in addition to the pigments mentioned above. The extender pigments used include, for example, calcium carbonate, kaolin, talc, silica, aluminum silicate, alumina, barium sulfate, etc. The extender pigment may be used in an amount of 30% by weight or less, and preferably in an amount of from 5% by weight to 20% by weight.

The aqueous painting material composition of the invention preferably comprises a thickening agent. Examples of the thickening agents used include, for example, bentonite, metallic soap, urethane block polymer, etc. The thickening agent used is not limited to those exemplified above; however, bentonite is particularly preferred since it has an appropriate thickening effect, and yet it does not affect the water resistance and washability with water of the coating film that the resulting aqueous painting material composition provides.

The thickening agent may be used usually in an amount of 10% by weight or less, and preferably in an amount of from 0.1% by weight to 10% by weight, more preferably in an amount of from 0.5% by weight to 5% by weight based on the weight of the aqueous painting material composition.

### (Water-Soluble Resin)

In the aqueous painting material composition of the invention, a hydroxyalkyl cellulose only is used as the water-soluble resin. The hydroxyalkyl cellulose is used not only as a dispersing agent for dispersing pigments in the aqueous painting material composition, but also as a fixing agent for fixing a coating film the aqueous painting material composition forms on a painting surface in collaboration with an emulsion resin. And, on the other hand, it is used so that it provides such an aqueous painting material composition with washability with water, that is, so that such an aqueous painting material composition has a weak solubility to water.

That is, the hydroxyalkyl cellulose is used so that, even if the aqueous painting material composition has adhered to a palette or a paintbrush, and dried, it can yet be removed from the palette or the paintbrush by washing it with water.

According to the invention, the hydroxyalkyl cellulose is the sole water-soluble resin used in the aqueous painting material composition, and as the hydroxyalkyl cellulose, at least one selected from the group consisting of hydroxyethyl cellulose, hydroxyethylmethyl cellulose, hydroxyethylethyl cellulose, hydroxypropylmethyl cellulose, and hydroxypropylhydroxyethyl-methyl cellulose is preferably used as the hydroxyalkyl cellulose. The aqueous painting material composition of the invention comprises the at least one hydroxyalkyl cellulose in an amount of from 0.1% by weight to 8% by weight, preferably in an amount of from 0.3% by weight to 7% by weight.

When the amount of the hydroxyalkyl cellulose in the aqueous painting material composition is less than 0.1% by weight, it has an insufficient fixing ability when painting, although it provides a coating film washable with water even after it has dried.

However, when the amount of the hydroxyalkyl cellulose in the aqueous painting material composition is more than 8% by weight, it does not provide a coating film washable with water after it has dried, but also it has an excessively high viscosity so that it does not spread well when painting.

When a resin other than the hydroxyalkyl cellulose, such as carboxymethyl cellulose or dextrin, for example, is used as a water-soluble resin, even if the content of resin emulsion in the aqueous painting material composition is less than 5% by weight, the resulting aqueous painting material composition only provides a coating film inferior in water resistance even after it has dried, so that when waterdrops adhere to the coating film after it has dried, it runs or dissolves in water.

Further, when the resulting aqueous painting material composition forms a coating film as an undercoating film, and then a second aqueous painting material composition is coated thereon, the undercoating film is shifted even after it has dried. Even if a large amount of resin emulsion is used, the resulting aqueous painting material composition is still inferior in water resistance.

When the aqueous painting material composition contains carboxymethyl cellulose or dextrin as a water-soluble resin, the resulting aqueous painting material composition only provides a coating film inferior in water resistance even after it has dried as mentioned above. Even if carboxymethyl cellulose or dextrin is used in combination with the hydroxyalkyl cellulose, it still affects the water resistance of the resulting aqueous painting material composition. Such being the case, the aqueous painting material composition of the invention uses the hydroxyalkyl cellulose as the sole water-soluble resin.

### (Resin Emulsions)

The aqueous painting material composition of the invention contains a hydroxyalkyl cellulose only as the sole water-soluble resin, as mentioned above. The hydroxyalkyl cellulose provides a coating film with a weak solubility to water even after it has dried, and on the other hand, a resin emulsion is used to provide the coating film with water resistance after it has dried.

The resin emulsion used in the invention is not limited to specific ones, and examples of the resin emulsion used preferably include, for example, emulsions of synthetic resins such as acrylic resin, vinyl acetate resin, acrylic-styrene resin, vinyl acetate-acrylic resin, ethylene-vinyl acetate resin, vinyl acetate-versatic acid-vinyl ester resin, ethylene-vinyl chloride resin, acrylic-Veova resin, vinyl chloride resin, vinyl chloride-vinylidene chloride resin, styrene resin, etc.

According to the invention, when the dispersibility of pigments in aqueous painting material composition and costs for production of the aqueous painting material composition are taken into consideration, acrylic resin emulsion, vinyl acetate resin emulsion, or vinyl acetate-acrylic resin emulsion is in particular used preferably.

Examples of such resin emulsions include, for example, Movinyl DM-772 (manufactured by The Nippon Synthetic Chemical Industry Co., Ltd.), Tocryl W-168 (Toyo Ink Manufacturing Co., Ltd.), and Nikasol RX866D (manufactured by Nippon Carbide Industries Co., Inc.) as acrylic resin emulsions; Movinyl DM-5 (manufactured by The Nippon Synthetic Chemical Industry Co., Ltd.) as vinyl acetate-acrylic resin emulsions; and Polysol AP-1900 (manufactured by Showa Denko K.K.) as acrylic-styrene resin emulsions.

The aqueous painting material composition of the invention comprises such a resin emulsion in an amount of from 0.1% by weight or more and less than 5% by weight, preferably in an amount of from 0.5% by weight to 4.9% by weight, and most preferably in an amount of from 0.5% by weight to 4.5% by weight, each in a solid basis. When the amount of the resin emulsion in the aqueous painting material composition is less than 0.1% by weight in a solid basis, the coating film formed on the painting surface may get cracked, but also it is not sufficient in fixing ability and water resistance after it has dried. However, on the contrary, when the amount of the resin emulsion in the aqueous painting material composition is more than 5% by weight in a solid basis, the resulting coating film can be removed only with difficulty when it is washed with water.

According to the invention, it is particularly preferred that the aqueous painting material composition of the invention comprises the resin emulsion in an amount mentioned above, and in addition, in a weight ratio thereof to the hydroxyalkyl cellulose of from 0.9 to 15, more preferably in a weight ratio of 0.95 to 10. The thus resulting aqueous painting material composition provides a coating film that is well balanced in water resistance and washability with water after it has dried.

### (Wetting Agents)

According to the invention, the aqueous painting material composition of the invention may comprise a wetting agent when necessary in order that it may be prevented from freezing or it may be delayed in drying. As the wetting agent, urea and its derivatives are preferably used in addition to polyhydric alcohols. The polyhydric alcohols used include, for example, glycerin, ethylene glycol, propylene glycol, dipropylene glycol, sorbitol, etc. The urea derivatives used include, for example, dimethylurea, tetramethyl-urea, tetraethylurea, thiourea, etc.

The wetting agent may be used, as needed, in an amount of 20% by weight or less in the aqueous painting material composition, preferably in an amount of 1% by weight to 15% by weight. When the amount of the wetting agent in the aqueous painting material composition is less than 1% by weight, the resulting coating film may be brittle when it has dried, depending on the case. On the other hand, when the amount of the wetting agent in the aqueous painting material composition is more than 20% by weight, the resulting coating film may be undesirably slowly dried.

### (Surfactants)

When necessary, the aqueous painting material composition of the invention may further comprise a surfactant selected from the group consisting of a nonion surfactant and an anion surfactant in an amount of from 0.1% by weight to 5% by weight, preferably in an amount of from 0.5% by weight to 3% by weight.

### (Other Additives)

Further according to the invention, the aqueous painting material composition of the invention may comprise a variety of additives used in the conventionally known aqueous painting material composition such as an antiseptic, an antifungal agent, a dispersing agent, and a defoaming agent, if needed.

### (Production)

The method for manufacturing the aqueous painting material composition of the invention is not limited to specific ones. By way of example, a water-soluble resin is dissolved in water to prepare an aqueous solution, a coloring pigment, an extender pigment, and water, and if necessary, a wetting agent, a surfactant, and an antiseptic, are added to the aqueous solution, the resulting mixture is stirred until it becomes uniform, the resulting mixture is then subjected to a dispersion treatment using a roll mill, and then a resin emulsion is added to the mixture and stirred, and then the mixture is vacuum defoamed, thereby the aqueous painting material composition of the invention is obtained.

### EXAMPLES

### Example 1

An aqueous painting material composition was prepared using the components shown in Table 1 each in an amount shown in Table 1 in such a manner as described above. The performance of the aqueous painting material composition thus obtained, i.e., palette washability, paintbrush washability, resistance to waterdrop, and extra layer additivity were evaluated. The results are shown in Table 1.

### Examples 2-6

An aqueous painting material composition was prepared using the components shown in Table 1 each in an amount shown in Table 1 in such a manner as described above. The performance of the aqueous painting material composition thus obtained, i.e., palette washability, paintbrush washability, resistance to waterdrop, and extra layer additivity were evaluated. The results are shown in Table 1.

### Comparative Examples 1-9

An aqueous painting material composition was prepared using the components shown in Table 2 each in an amount shown in Table 2 in such a manner as described above. The performance of the aqueous painting material composition thus obtained, i.e., palette washability, paintbrush washability, resistance to waterdrop, and extra layer additivity were evaluated. The results are shown in Table 2.

The details of the components listed in Tables 1 and 2 are as follows.

### (Components)

Coloring pigment: “Ultramarine #3000” manufactured by Daiichi Kasei Kogyo K.K.
Extender pigments:
Extender pigment 1: Light calcium carbonate manufactured by Shiraishi Kogyo Kaisha, Ltd.
Extender pigment 2: “Sipernat 820A”, aluminum silicate manufactured by Degussa Japan K.K.
Bentonite: Bentonite manufactured by K.K. Hojun
Water soluble resins:
Hydroxyethyl cellulose: “Tylose H20P2” manufactured by The Nippon Synthetic Chemical Industry Co., Ltd., having a viscosity of 20 mPa·s as measured with a 1% by weight aqueous solution using an ELD viscosity meter having a rotor 1° C. 34R for 3 minutes under the conditions of a temperature of 20° C. and a rotational speed of 5 rpm.
Hydroxyethyl cellulose: “Tylose H4000P2” manufactured by The Nippon Synthetic Chemical Industry Co., Ltd., having a viscosity of 4000 mPa·s as measured with a 1% by weight aqueous solution using an EHD viscosity meter having a rotor 1° C. 34R for 3 minutes under the conditions of a temperature of 20° C. and a rotational speed of 5 rpm.
Hydroxyethylmethyl cellulose: “Tylose M300P2” manufactured by The Nippon Synthetic Chemical Industry Co., Ltd. having a viscosity of 300 mPa·s as measured with a 1% by weight aqueous solution using an EHD viscosity meter having a rotor 1° C. C34R for 3 minutes under the conditions of a temperature of 20° C. and a rotational speed of 50 rpm.
Hydroxyethylmethyl cellulose: “Tylose M4000KG4” manufactured by The Nippon Synthetic Chemical Industry Co., Ltd. having a viscosity of 4000 mPa·s as measured with a 1% by weight aqueous solution using an EHD viscosity meter having a rotor 1° C. 34R under the conditions of a temperature of 20° C. and a rotational speed of 5 rpm.
Dextrin: “Akadama Dextrin 102-5” (roasted dextrin) manufactured by Nichiden Kagaku K.K.
Carboxymethyl cellulose: “Celogen 5A” manufactured by Dai-Ichi Kogyo Seiyaku Co., Ltd.
Resin emulsions
Vinyl-acetate acrylic resin emulsion: “Movinyl DM-5” (53% by weight of solid content) manufactured by The Nippon Synthetic Chemical Industry Co., Ltd.
Acrylic resin emulsion 1: “Movinyl DM-772” (46% by weight of solid content) manufactured by The Nippon Synthetic Chemical Industry Co., Ltd.
Acrylic resin emulsion 2: “Tocryl W-168” (50% by weight of solid content) manufactured by Toyo Ink Manufacturing Co., Ltd.

Acrylic resin emulsion 3: “Nikasol RX866D” (55% by weight of solid content) manufactured by Showa Denko K.K.

Styrene acrylic resin emulsion: “Polysol AP-1900” (50% by weight of solid manufactured by Showa Denko K.K.

### Surfactants

Surfactant 1: “Plysurf A-212E”, nonionic surfactant manufactured by Dai-Ichi Kogyo Seiyaku Co., Ltd.
Surfactant 2: “Nopuco 8034-L”, nonionic surfactant manufactured by San Nopco Ltd.
Surfactant 3: “Raberin FC-P”, anionic surfactant manufactured by Dai-Ichi Kogyo Seiyaku Co., Ltd.
Antiseptic: “SAN-AI Back SA” manufactured by San-Ai Oil Co., Ltd.

### (Evaluation of Performance)

### Palette Washability

An amount of 5 parts by weight of an aqueous painting material composition was mixed with 1 part by weight of water to prepare a painting material as a sample. The painting material was coated on a pellet made from high impact polystyrene using a flat tip design brush, and then the resulting coating film was dried at room temperature for a week. The painting material was adhered to the palette, and then the painting material was dried in this way. While tap water was poured on the palette, the palette was washed by scouring the dried painting material on the palette using a flat tip design brush.

In this manner, when 80% or more of the dried painting material adhering to the palette was washed away from the palette, the painting material was graded A; when 30% or more and less than 80% of the dried painting material was washed away from the palette, the painting material was graded B; and when less than 30% of the dried painting material was washed away from the palette, the painting material was graded C.

### Paintbrush Washability

An amount of 5 parts by weight of an aqueous painting material composition was mixed with 1 part by weight of water to prepare a painting material as a sample. A woolen flat tip paintbrush was smeared with the painting material, and then the paintbrush was left standing at room temperature for a week. The paintbrush was smeared with the sample painting material and then the painting material was dried in this way.

While tap water was poured on the paintbrush, the brush was washed by rubbing. In this manner, when 80% or more of the dried painting material adhering to the paintbrush was washed away from the brush, the painting material was graded A; when 30% or more and less than 80% of the dried painting material was washed away from the paintbrush, the painting material was graded B; and when less than 30% of the dried painting material was washed away from the paintbrush, the painting material was graded C.

### Resistance to Waterdrops

An amount of 5 parts by weight of an aqueous painting material composition was mixed with 1 part by weight of water to prepare a painting material as a sample. The painting material was coated on a sheet of drawing paper three times using a flat tip design brush to form a three layer coating film. After the resulting coating film was dried at room temperature for 1 hour, one drop of tap water was dropped on the coating film using a 1 mL capacity syringe. After the coating film was allowed to stand at room temperature for 6 hours, it was checked whether any change occurred on the coating film.

When no change was found on the coating film, the painting material was graded A; and when cracks, discoloration and/or prints of waterdrops were found on the coating film, the painting material was graded C.

### Additivity of Extra Layers

An amount of 5 parts by weight of an aqueous painting material composition was mixed with 1 part by weight of water to prepare a painting material as a sample. The sample painting material was coated on a sheet of drawing paper three times using a flat tip design brush. The resulting coating film was then dried at room temperature for 1 hour, thereby an undercoating film was prepared.

An amount of 5 parts by weight of an acrylic paint, “Acrylic Gouache” (manufactured by Sakura Color Products Corporation) was mixed with 1 part by weight of water, and was coated on the undercoating film three times, i.e., lengthwise, breadthwise, and again lengthwise. When the acrylic paint was able to be coated on the undercoating film with no problem, the painting material was graded A; and when the acrylic paint was coated on the undercoating film, and the undercoating film was found to shift, or ran in water, the painting material was graded C.

TABLE 1

| | | EXAMPLES | | | | | | | | | |
|---|---|---|---|---|---|---|---|---|---|---|---|
| | | 1 | 2 | 3 | 4 | 5 | 6 | 7 | 8 | 9 | 10 |
| Components of Painting Material Composition | | | | | | | | | | | |
| (parts by weight) | | | | | | | | | | | |
| Coloring pigments | | 30.0 | 30.0 | 30.0 | 30.0 | 30.0 | 30.0 | 30.0 | 30.0 | 30.0 | 30.0 |
| Extender pigments | | | | | | | | | | | |
| Extender pigment 1 | | 10.0 | 10.0 | 10.0 | 10.0 | 10.0 | 10.0 | 10.0 | 10.0 | 10.0 | 10.0 |
| Extender pigment 2 | | 3.0 | 3.0 | 3.0 | 3.0 | 3.0 | 3.0 | 3.0 | 3.0 | 3.0 | 3.0 |
| Bentonite | | 3.0 | 3.0 | 3.0 | 3.0 | 3.0 | 3.0 | 3.0 | 3.0 | 3.0 | 3.0 |
| Water-soluble resins | | | | | | | | | | | |
| Hydroxyethyl cellulose | | | | | | | | | 1.0 | | |
| Hydroxyethyl cellulose | | 0.5 | 0.5 | 0.5 | 0.5 | 0.5 | 0.5 | 5.0 | 0.3 | | |
| Hydroxyethylmethyl cellulose | | | | | | | | | | | 1.0 |
| Hydroxyethylmethyl cellulose | | | | | | | | | | 0.5 | 0.3 |
| Dextrin | | | | | | | | | | | |
| Carboxymethyl cellulose | | | | | | | | | | | |
| Resin emulsions | | | | | | | | | | | |
| Vinyl acetate-acrylic resin emulsion | | 1.0 | 4.5 | | | | | 4.9 | 4.0 | 4.0 | 4.0 |
| Acrylic emulsion 1 | | | | 3.0 | | | | | | | |
| Acrylic emulsion 2 | | | | | 3.0 | | | | | | |
| Acrylic emulsion 3 | | | | | | 4.5 | | | | | |
| Styrene-acrylic resin emulsion | | | | | | | 4.7 | | | | |
| Wetting agent: Propylene glycol | | 8.0 | 8.0 | 8.0 | 8.0 | 8.0 | 8.0 | 8.0 | 8.0 | 8.0 | 8.0 |
| Surfactants | | | | | | | | | | | |
| Surfactant 1 | | 1.0 | 1.0 | 1.0 | 1.0 | 1.0 | 1.0 | 1.0 | 1.0 | 1.0 | 1.0 |
| Surfactant 2 | | 0.2 | 0.2 | 0.2 | 0.2 | 0.2 | 0.2 | 0.2 | 0.2 | 0.2 | 0.2 |
| Surfactant 3 | | | | | | | | | | | |
| Anticeptics | | 0.3 | 0.3 | 0.3 | 0.3 | 0.3 | 0.3 | 0.3 | 0.3 | 0.3 | 0.3 |
| Water | | 43.0 | 39.5 | 41.0 | 41.0 | 39.5 | 39.3 | 34.6 | 39.2 | 40.0 | 39.2 |
| Total | | 100.0 | 100.0 | 100.0 | 100.0 | 100.0 | 100.0 | 100.0 | 100.0 | 100.0 | 100.0 |
| Performance of Painting Material Composition | | | | | | | | | | | |
| Washability: | Palette washability | A | A | A | A | A | A | A | A | A | A |
| | Paintbrush washability | A | A | A | A | A | A | A | A | A | A |
| Water resistance: | Resistance to waterdrops | A | A | A | A | A | A | A | A | A | A |
| | Additivity of extra layers | A | A | A | A | A | A | A | A | A | A |

TABLE 2

| | | COMPARATIVE EXAMPLES | | | | | | | | |
|---|---|---|---|---|---|---|---|---|---|---|
| | | 1 | 2 | 3 | 4 | 5 | 6 | 7 | 8 | 9 |
| Components of Painting Material Composition | | | | | | | | | | |
| (parts by weight) | | | | | | | | | | |
| Coloring pigments | | 30.0 | 30.0 | 30.0 | 30.0 | 30.0 | 30.0 | 30.0 | 30.0 | 30.0 |
| Extender pigments | | | | | | | | | | |
| Extender pigment 1 | | 10.0 | 5.0 | 10.0 | 10.0 | 5.0 | 5.0 | 5.0 | 5.0 | 5.0 |
| Extender pigment 2 | | 3.0 | 3.0 | 3.0 | 3.0 | 3.0 | 3.0 | 3.0 | 3.0 | 3.0 |
| Bentonite | | 3.0 | 3.0 | 3.0 | 3.0 | 3.0 | 3.0 | 3.0 | 3.0 | 3.0 |
| Water-soluble resins | | | | | | | | | | |
| Hydroxyethyl cellulose | | | | | | | | | | |
| Hydroxyethyl cellulose | | 0.5 | 0.5 | 10.0 | | | | | | |
| Hydroxyethylmethyl cellulose | | | | | | | | | | |
| Hydroxyethylmethyl cellulose | | | | | | | | | | |
| Dextrin | | | | | 0.5 | 0.5 | 15.0 | | 15.0 | |
| Carboxymethyl cellulose | | | | | | | | 7.0 | | 7.0 |
| Resin emulsions | | | | | | | | | | |
| Vinyl acetate-acrylic resin emulsion | | 10.0 | 15.0 | 4.5 | 4.5 | 20.0 | 4.0 | 4.0 | 20.0 | 20.0 |
| Acrylic emulsion | | | | | | | | | | |
| Wetting agent: Propylene glycol | | 8.0 | 8.0 | 8.0 | 8.0 | 8.0 | 8.0 | 8.0 | 8.0 | 8.0 |
| Surfactants | | | | | | | | | | |
| Surfactant 1 | | 1.0 | 1.0 | 1.0 | 1.0 | 1.0 | 1.0 | 1.0 | 1.0 | 1.0 |
| Surfactant 2 | | 0.2 | 0.2 | 0.2 | 0.2 | 0.2 | 0.2 | 0.2 | 0.2 | 0.2 |
| Surfactant 3 | | | | | | | 0.4 | 0.4 | 0.4 | 0.4 |
| Anticeptics | | 0.3 | 0.3 | 0.3 | 0.3 | 0.3 | 0.3 | 0.3 | 0.3 | 0.3 |
| Water | | 34.0 | 34.0 | 30.0 | 39.5 | 29.0 | 30.1 | 38.1 | 30.1 | 38.1 |
| Total | | 100.0 | 100.0 | 100.0 | 100.0 | 100.0 | 100.0 | 100.0 | 116.0 | 116.0 |
| Performance of Painting Material Composition | | | | | | | | | | |
| Washability: | Palette washability | B | C | A | A | A | A | A | B | B |
| | Paintbrush washability | B | C | A | A | A | A | A | B | B |
| Water resistance: | Resistance to waterdrops | A | A | C | C | C | C | C | C | C |
| | Additivity of extra layers | A | A | C | C | C | C | C | C | C |

As shown in Table 1, the aqueous painting material composition comprising the resin emulsion in an amount of 0.1% by weight or more and less than 5% by weight, and the hydroxyalkyl cellulose only as the water-soluble resin according to the invention provides a coating film which is excellent in resistance to waterdrops, like the conventional emulsion paint. That is, after the coating film has dried, it neither runs nor dissolves in water even if waterdrops adhere to the coating film, and an extra layer of a second aqueous painting material composition can be added thereon.

As set out above, the aqueous painting material composition of the invention has water resistance in such a degree that even if an extra layer of a second aqueous painting material composition is added on an undercoating film of the aqueous painting material composition, the undercoating film is not shifted, and even if it has adhered to a palette or a paintbrush, and dried, it can be washed away from it by washing it with water.

In contrast, as the aqueous painting material compositions of Comparative Examples 1 and 2 contain a resin emulsion in an excessive amount compared to those of Examples 1 and 2, as shown in Table 2, the coating films thereof are excellent in water resistance after they have dried, but they are inferior in washability with water even if they have dried.

The aqueous painting material composition of Comparative Example 3 contains a resin emulsion within an amount prescribed in the invention. However, it contains a hydroxyalkyl cellulose as a water-soluble resin in an excessive amount, so that the coating film thereof is excellent in washability with water after drying, but it is inferior in water resistance even if it has dried.

The aqueous painting material composition of Comparative Example 4 contains a resin emulsion within an amount prescribed in the invention, but it contains dextrin as a water-soluble resin. The amount of dextrin is the same as that of the hydroxyalkyl cellulose in the aqueous painting material composition of Example 1. The aqueous painting material composition of Comparative Example 4 provides a coating film that is washable with water after drying, but is inferior in water resistance after it has dried.

Then, the aqueous painting material composition of Comparative Example 5 was prepared so as to contain a much larger amount of the resin emulsion than the composition of Comparative Example 4. It provides a coating film that is washable with water after drying, but is inferior in water resistance after it has dried, like the composition of Comparative Example 4.

The aqueous painting material composition of Comparative Example 6 contains a resin emulsion in an amount prescribed in the invention. As the composition contains dextrin in a large amount, it provides a coating film which has washability with water after drying, but which is inferior in water resistance even after it has dried.

The aqueous painting material composition of Comparative Example 7 contains a resin emulsion in an amount prescribed in the invention. However, as the composition contains carboxymethyl cellulose as a water-soluble resin. As a result, the composition provides a coating film which is washable with water after drying, but it is inferior in water resistance after it has dried.

The aqueous painting material compositions of Comparative Examples 8 and 9 contains dextrin and carboxymethyl cellulose as a water-soluble resin, respectively, but also a large amount of a resin emulsion. As a result, they provide a coating film which is still insufficient in water resistance even if after it has dried.

1. An aqueous painting material composition which comprises water, a coloring pigment, a water-soluble resin, and a resin emulsion, wherein the aqueous painting material composition contains a hydroxyalkyl cellulose only as the water-soluble resin, and the resin emulsion in an amount of from 0.1% by weight or more and less than 5% by weigh in a solid basis.

2. The aqueous painting material composition according to claim 1 wherein the hydroxyalkyl cellulose is at least one selected from the group consisting of hydroxyethyl cellulose, hydroxyethylmethyl cellulose, and hydroxypropylmethyl cellulose.

3. The aqueous painting material composition according to claim 1 which comprises the hydroxyalkyl cellulose in an amount of from 0.1% by weight to 8% by weight.

4. The aqueous painting material composition according to claim 1 which comprises the resin emulsion in a weight ratio of the resin emulsion to the hydroxyalkyl cellulose of from 0.9 to 15.

5. The aqueous painting material composition according to claim 1 which further comprises bentonite as a thickening agent.

6. The aqueous painting material composition according to claim 1 which further comprises an extender pigment.

7. The aqueous painting material composition according to claim 1 which further comprises at least one additive selected from the group consisting of a wetting agent, a surfactant, and an antiseptic.
